(19) United States
(12) Patent Application Publication
(10) Pub. No.: US 2015/0294268 A1
(43) Pub. Date: Oct. 15, 2015

(54) PRORATION CALCULATION IN A LOGISTICS MANAGEMENT SYSTEM (LMS)

(71) Applicants: William A. Loebertmann, Eagan, MN (US); Joann E. Jancik, Eagan, MN (US); Matthew Marth, Eagan, MN (US); Irina Shofman, Eagan, MN (US)

(72) Inventors: William A. Loebertmann, Eagan, MN (US); Joann E. Jancik, Eagan, MN (US); Matthew Marth, Eagan, MN (US); Irina Shofman, Eagan, MN (US)

(73) Assignee: UNISYS CORPORATION, Blue Bell, PA (US)

(21) Appl. No.: 14/252,085

(22) Filed: Apr. 14, 2014

(51) Int. Cl. G06Q 10/08

(52) U.S. Cl. CPC G06Q 10/08345

(57) ABSTRACT

Shipping costs may be prorated in advance of accepting the reservation for transporting cargo, such as by determining whether the cargo is profitable for the LMS client, The proration may he performed according to a special prorate agreement (SPA). A method for calculating the prorated amounts may include receiving a segment and a carrier for shipping cargo, determining if a special prorate agreement (SPA) exists for the segment, and calculating, when the SPA exists, a proration amount for the segment based, at least in part, on the SPA. A decision may be made to accept the reservation or not based on whether the reservation is profitable by comparing the calculated amount to a hurdle rate.

### FIELD OF THE DISCLOSURE

The instant disclosure relates to computer systems. More specifically, this disclosure relates to logistics management systems (LMSs).

### BACKGROUND

A hurdle rate is defined as a simple rate per unit of weight by product type and hooking segment. The hurdle rate is the floor minimum above which a shipment rate must be charged for the shipment to be profitable. The hurdle rate can be calculated as an average by product and booking segment and does not consider complex rating for shipper-loaded ULDs, commodities, class rates, mixed consignments, and RCPs.

The hurdle rate provides useful information to airlines that could assist in the optimization of revenue streams by determining whether to accept a reservation for a cargo shipment. Many times revenue relating to a cargo shipment are split between carriers according to a special prorate agreement (SPA). Thus, the known amount an airline will receive for handling the cargo shipment for their segment(s) of the entire shipment routing is difficult to determine ahead of time.

### SUMMARY

Prorating shipment costs may be performed in a logistics management system (LMS) before acceptance of a package for delivery. By prorating upfront at the time of accepting a reservation for a cargo shipment, the LMS may optimize airline revenue by determining whether a particular package is profitable. In certain situations, a bilateral agreement may determine how the revenue for transporting the shipment is split amongst the airlines transporting the shipment, and the LMS may apply the agreement to calculate a particular airline's revenue for transporting the shipment. The revenue may he compared to criteria to determine whether to accept a reservation tor a cargo shipment. For example, the revenue may be compared to a hurdle rate to decide if the shipment is profitable and should be accepted.

Embodiments described below support Special Prorate Agreements (SPA) for interline proration in a logistics management system (LMS). For example, if an SPA exists, then the LMS may use the SPA for proration. If an SPA does not exist that applies to an air waybill being evaluated, then the LMS may use the great circle mileage calculation to determine the proration. Calculations for sharing the revenue of the air waybill may be performed at the time a reservation is made.

A logistics management system (LMS) may be used to determine whether the LMS client's revenue for an air waybill is calculated from SPAs or the great circle mileage calculation. For an air waybill issued by an LMS client, the SPA defines the amount of the total revenue that must be paid to other airlines, the SPA cost, that are involved in the air waybill booking. The total revenue minus the SPA cost may be calculated to determine the LMS client's portion of the revenue. For air waybills issued by other airlines in which the LMS client carries the shipment for all or part of the total routing, the SPA defines the revenue that the LMS client will receive from the other airline for that air waybill. In the event, an SPA does not apply, then great circle mileage is used, and the mileage for each segment of the booking is calculated. The mileage is then used to determine the LMS client's percent of the total flown distance. The revenue is then split by the percent of total distance the LMS client carries the shipment. Once the LMS client's revenue is determined based on the SPA or great circle mileage method, the LMS client's revenue may be divided by the weight of the shipment to obtain the LMS client's revenue rate per unit of weight. Then, the LMS client's revenue rate may be compared to a hurdle rate to determine if the reservation for the shipment may be accepted.

A proration module in an LMS may have some or all of the following features for interline proration, such as some or all of the features described above. Proration may be calculated using SPAs, if one exists for the carrier and segment specified on an air waybill. If no SPAs exist, then mileage based on the Great Circle calculation may be used. If an SPA is found, then SPA defines the amount that must be paid to the airline. To determine the host's revenue this amount may be subtracted from the host carrier's actual rate. The host may be, for example, the LMS airline client using the LMS. According to one embodiment, an SPA cost, when defined on the per kilogram basis, may be calculated using the actual chargeable weight. The actual chargeable weight may be the highest of the gross weight or dimensional weight unless the pricing module determines that a higher weight break applies. If an SPA is not found, then mileage based on the great circle calculation may be used, Mileage determines the percentage of distance the host and airline carry the shipment. The percentages are then applied to the published rate to determine the amount owed the airline. This amount is then subtracted from the host airlines actual rate to determine the host airlines revenue.

Airlines may optimize revenue by determining a proration amount for cargo for a segment upfront to determine whether to accept the reservation for the shipment. The determination of the proration amount may improve (profitability when multiple airlines are involved to the proration amount each airline will receive. The proration amount may be determined upfront before the reservation according to bilateral agreements (previously-entered regarding the shipping for certain segments. The determined proration amount may be compared to a hurdle rate to determine whether the cargo is profitable and should be accepted. In different embodiments, the proration amount may be fixed by geography, mileage, and/or percentages.

According to one embodiment, a method may include receiving a segment and a carrier for shipping cargo; determining if a special prorate agreement (SPA) exists for the segment; and calculating, when the SPA exists, a proration amount for the segment based, at least in part, on the SPA.

According to another embodiment, a computer program product may include a non-transitory computer readable medium comprising code to perform the steps of receiving a segment and a carrier for shipping cargo; determining if a special prorate agreement (SPA) exists for the segment; and calculating, when the SPA exists, a proration amount for the segment based, at least in part, on the SPA.

According to a further embodiment, an apparatus may include a memory, and a processor coupled to the memory. The processor may be configured to execute the steps of receiving a segment and a carrier for shipping cargo; determining if a special prorate agreement (SPA) exists for the segment; and calculating, when the SPA exists, a proration amount for the segment based, at least in part, on the SPA.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention, it should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is flow chart illustrating a method of prorating a shipment according to one embodiment of the disclosure.

FIG. 2 is a flow chart illustrating another method of prorating a shipment according to one embodiment of the disclosure.

FIG. 3 is a block diagram illustrating a computer network according to one embodiment of the disclosure.

FIG. 4 is a block diagram illustrating a computer system according to one embodiment of the disclosure.

### DETAILED DESCRIPTION

There are three components to cargo revenue management that may be used by LMS during the booking confirmation processing: forecast the future flight capacity available for cargo (Flight Capacity Forecast), determining the host revenue and yield for the shipment. (Proration of Revenue), and forecasting the bid prices (hurdle rates) for controlling access to capacity. This information may also be used by other logistics business functions, such as during negotiations of allotments, spot rate agreements, and contracts.

The LMS Hurdle Rate table may be populated with the hurdle rates derived manually or from an external cargo revenue management application (CRM). This enables LMS to automatically apply hurdle rate restrictions at the time of booking confirmation. In one embodiment, CRM may sends the hurdle rates to LMS on a daily basis using File Transfer Protocol (FTP).

At the time of booking, route and price requests, and/or during air waybill (AWB) capture, LMS prices the shipment or price request, and then prorates the transportation and other charges considered as revenue between the carriers transporting the shipment using a special prorate agreement (SPA) if one exists and a Great Circle mileage proration method otherwise.

LMS provides the interline and online proration information only to authorized users as controlled by View Revenue Management and Full Revenue Management user levels on the User Administration function, and/or other parameters. Routing and Price, Booking Information, and AWB Information sections display the amounts chargeable to the customer (e.g. transportation and other charges) and revenue fields (e.g. host revenue and yield). The proration information is provided in the Revenue section of the Booking Information and AWB Information functions. Authorized users are able to select revenue data to be included in list functions, such as Flight Booking Restrictions, Outbound Flight inventory, etc.

LMS prices the shipment and/or routing and pricing request's transportation charges and other charges associated with the shipment or request. When the air waybill paper (ACN) is the LMS client's, the Gross Revenue is calculated as the Total Actual Weight Charges plus any other charges that are considered revenue (e.g. Fuel Surcharge) as indicated by other functions. When the air waybill paper (ACN) is other airline paper, the Gross Revenue is calculated as the Total Actual Weight Charges.

When multiple carriers transport the shipment, as identified by the air waybill routing, LMS prorates the Gross Revenue between the carriers using the special prorate agreement (SPA) if one exists or otherwise the Great Circle Mileage algorithms. From this, the LMS client's Revenue is derived. The LMS client's Revenue is then prorated between the client's booking segments (or flight segments for the routing and price request) using the Great Circle Mileage algorithms.

The prorated amounts may be stored with the booking or air waybill, and are available for display on the booking, air waybill, and list function displays for authorized users. When the airline is using the Cargo Revenue Management feature, then the Revenue Rate is compared to the Hurdle Rate for use in booking confirmation.

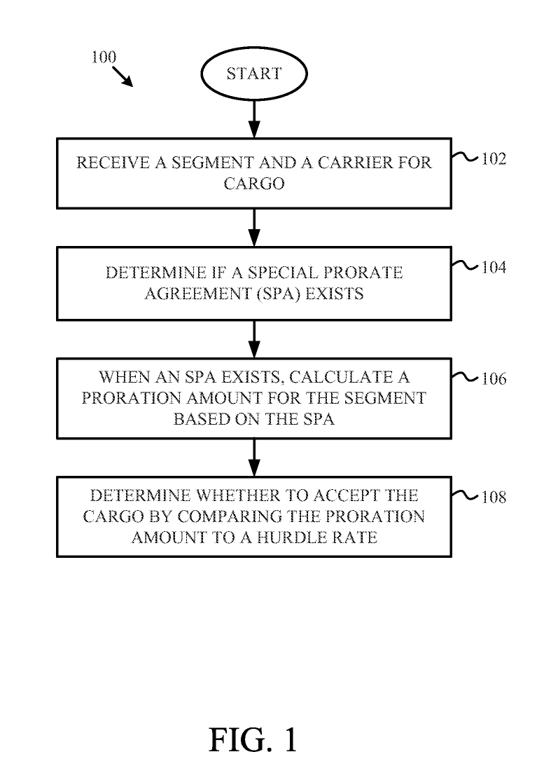

FIG. 1 is flow chart illustrating a method of prorating a shipment according to one embodiment of the disclosure. A method 100 begins at block 102 with receiving a segment and a carrier for a cargo shipment. At block 104, it is determined if a special prorate agreement (SPA) exists.

At block 106, when an SPA exists, a logistics management system (LMS) calculates a proration amount for the segment based on the SPA. During calculation of the proration amount, the LMS may receive, from a database, a published rate for the segment and calculate the proration amount based on the received published rate, In one embodiment, the received published rate may include an airline-specific published rate and/or a general published rate.

At block 108, it is determined whether to accept the cargo by comparing the proration amount to one or more criteria, including a hurdle rate. The hurdle rate may be received by the LMS from a Cargo Revenue Management (CRM) application that applies statistical algorithms to historical data received from a logistics management system (LMS) to forecast customer demand and available capacity.

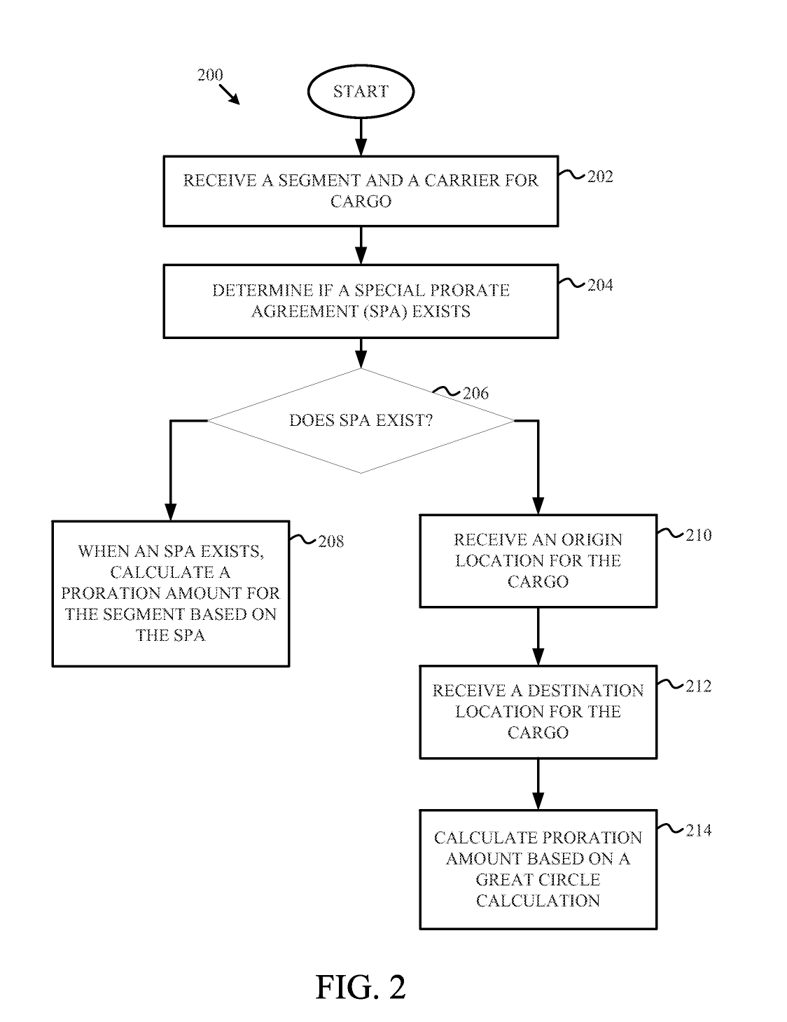

FIG. 2 is a flow chart illustrating another method of prorating a shipment according to one embodiment of the disclosure. A method 200 begins at block 202 with receiving a segment and a carrier for a cargo shipment. At block 204, it is determined if a special prorate agreement (SPA) exists for the carrier. When an SPA exists at block 206, the method 200 continues to block 208 to calculate a proration amount for the segment based on the SPA. When no SPA exists at block 206, the method 200 continues to block 210.

At block 210, an origin location is received for the cargo, and at block 212, a destination location is received for the cargo. At block 214, a proration amount may be calculated by the LMS based on a great circle calculation, such as by determining a distance for a straight line between the origin and destination locations and computing a percentage of that distance based on the segment for the cargo.

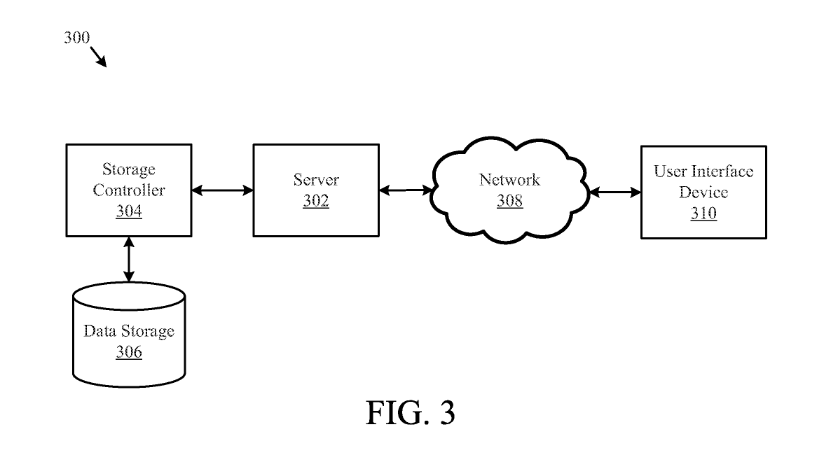

FIG. 3 illustrates one embodiment of a system 300 for an information system, including a system for calculated prorated amounts. The system 300 may include a server 302, a data storage device 306, a network 308, and a user interface device 310. The server 302 may also be a hypervisor-based system executing one or more guest partitions hosting operating systems with modules having server configuration information. In a further embodiment, the system 300 may include a storage controller 304, or a storage server configured. to manage data communications between the data storage device 306 and the server 302 or other components in communication with the network 308. In an alternative embodiment, the storage controller 304 may be coupled to the network 308.

In one embodiment, the user interface device 310 is referred to broadly and is intended to encompass a suitable processor-based device such as a desktop computer, a laptop computer, a personal digital assistant (PDA) or tablet computer, a smartphone or other mobile communication device having access to the network 308. When the device 310 is a mobile device, sensors (not shown), such as a camera or accelerometer, may be embedded in the device 310, When the device 310 is a desktop computer the sensors may be embedded in an attachment (not shown) to the device 310. In a further embodiment, the user interface device 310 may access the Internet or other wide area or local area network to access a web application or web service hosted by the server 302 and may provide a user interface for enabling a user to enter or receive information.

The network 308 may facilitate communications of data between the server 302 and the user interface device 310. The network 308 may include any type of communications network including, but not limited to, a direct PC-to-PC connection, a local area. network (LAN), a wide area network (WAN), a modem-to-modem connection, the Internet, a combination of the above, or any other communications network now known or later developed within the networking arts which permits two or more computers to communicate.

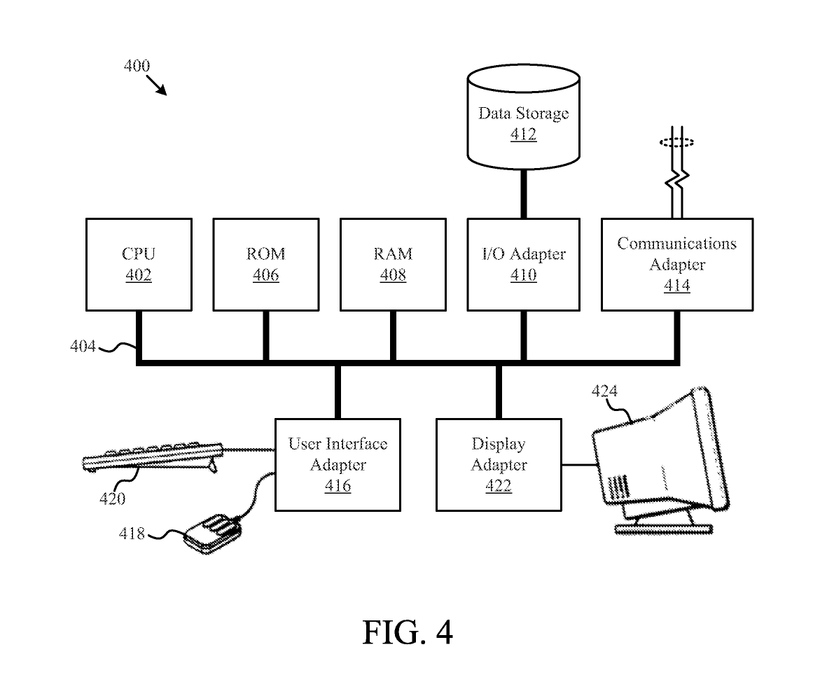

FIG. 4 illustrates a computer system 400 adapted according to certain embodiments of the server 302 and/or the user interface device 310. The central processing unit (“CPU”) 402 is coupled to the system bus 404. The CPU 402 may be a general purpose CPU or microprocessor, graphics processing unit (“GPU”), and/or microcontroller. The present embodiments are not restricted by the architecture of the CPU 402 so long as the CPU 402, whether directly or indirectly, supports the operations as described herein. The CPU 402 may execute the various logical instructions according to the present embodiments.

The computer system 400 also may include random access memory (RAM) 408, which may be synchronous RAM (SRAM), dynamic RAM (DRAM), synchronous dynamic RAM (SDRAM), or the like. The computer system 400 may utilize RAM 408 to store the various data structures used by a software application. The computer system 400 may also include read only memory (ROM) 406 which may be PROM, EPROM, EEPROM, optical storage, or the like. The ROM may store configuration information for booting the computer system 400. The RAM 408 and the ROM 406 hold user and system data, and both the RAM 408 and the ROM 406 may he randomly accessed.

The computer system 400 may also include an input/output (I/O) adapter 610, a communications adapter 414, a user interface adapter 416, and a display adapter 422. The I/O adapter 410 and/or the user interface adapter 416 may, in certain embodiments, enable a user to interact with the computer system 400. In a further embodiment, the display adapter 422 may display a graphical user interface (GUI) associated with a software or web-based application on a display device 424, such as a monitor or touch screen, to allow input of cargo shipments and SPAs.

The I/O adapter 410 may couple one or more storage devices 412, such as one or more of a hard drive, a solid state storage device, a flash drive, a compact disc (CD) drive, a floppy disk drive, and a tape drive, to the computer system 400. According to one embodiment, the data storage 412 may be a separate server coupled to the computer system 400 through a network connection to the I/O adapter 410. The communications adapter 414 may be adapted to couple the computer system 400 to the network 308, which may be one or more of a LAN, WAN, and/or the Internet. The user interface adapter 416 couples user input devices, such as a keyboard 420, a pointing device 418, and/or a touch screen (not shown) to the computer system 400. The display adapter 422 may be driven by the CPU 402 to control the display on the display device 424. Any of the devices 402-422 may be physical and/or logical.

The applications of the present disclosure are not limited to the architecture of computer system 400. Rather the computer system 400 is provided as an example of one type of computing device that may be adapted to perform the functions of the server 302 and/or the user interface device 310. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 400 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a segment and a carrier for shipping cargo;
determining if a special prorate agreement (SPA) exists for the segment;
calculating, when the SPA exists, a proration amount for the segment based, at least in part, on the SPA;
receiving a hurdle rate for the segment; and
comparing the proration amount to the hurdle rate to determine whether to accept the reservation for the shipment.

2. The method of claim 1, in which the step of calculating the proration amount based on the SPA comprises:
receiving, from a database, a published rate for the segment; and
calculating the proration amount based on the received published rate.

3. The method of claim 2, in which the step of receiving the published rate comprises at least one of receiving an airline-specific published rate and receiving a general published rate.

4. The method of claim 1, further comprising calculating, when no SPA exists, the proration amount based, at least in part, a great circle calculation, in which the step of calculating comprises:
receiving an origin location for the shipping cargo;
receiving a destination location for the shipping cargo; and
calculating the proration amount based on a great circle calculation of the distance from the origin location to the destination location and based on a percentage corresponding to the segment.

5. The method of claim 1, in which the step of determining if the special prorate agreement (SPA) exists comprises searching an SPA database based, at least in part, on the segment and a LMS client airline for shipping the cargo.

6. The method of claim 1, in which the step of receiving a hurdle rate comprises receiving the hurdle rate from a Cargo Revenue Management (CRM) application that applies statistical algorithms to historical data received from a logistics management system (LMS) to forecast customer demand and available capacity.

7. The method of claim 6, in which the hurdle rate is the minimum acceptable rate at which the product is to be sold for a booking segment.

8. A computer program product, comprising:
a non-transitory computer readable medium comprising code to perform the steps of:
receiving a segment and a carrier for shipping cargo;
determining if a special prorate agreement (SPA) exists for the segment;
calculating, when the SPA exists, a proration amount for the segment based, at least in part, on the SPA;
receiving a hurdle rate for the segment; and
comparing the proration amount to the hurdle rate to determine whether to accept the shipping cargo.

9. The computer program product of claim 8, in which the medium further comprises code to perform the steps of:
receiving, from a database, a published rate for the segment; and
calculating the proration amount based on the received published rate.

10. The computer program product of claim 9, in which the medium further comprises code to perform the step of receiving an airline-specific published rate and receiving a general published rate.

11. The computer program product of claim 8, in which the medium further comprises code to perform the step of calculating, when no SPA exists, the proration amount based, at least in part, a great circle calculation, in which the step of calculating comprises:
receiving an origin location for the shipping cargo;
receiving a destination location for the shipping cargo; and
calculating the proration amount based on a straight line distance from the origin location to the destination location and based on a percentage corresponding to the segment.

12. The computer program product of claim 8, in which the step of determining if the special prorate agreement (SPA) exists comprises searching an SPA database based, at least in part, on the segment and a host airline for the shipping cargo.

13. The computer program product of claim 12, in which the hurdle rate is the minimum acceptable rate at which the product is to be sold for a booking segment.

14. An apparatus, comprising:
a memory; and
a processor coupled to the memory, the processor configured to execute the steps of:
receiving a segment and a carrier for shipping cargo;
determining if a special prorate agreement (SPA) exists for the segment;
calculating, when the SPA exists, a proration amount for the segment based, at least in part, on the SPA;
receiving a hurdle rate for the segment; and
comparing the proration amount to the hurdle rate to determine whether to accept the shipping cargo.

15. The apparatus of claim 14, in which the processor is further configured to execute the steps of:
receiving, from a database, a published rate for the segment; and
calculating the proration amount based on the received published rate.

16. The apparatus of claim 15, in which the processor is further configured to execute the step of receiving an airline-specific published rate and receiving a general published rate.

17. The apparatus of claim 14, in which the processor is further configured to execute the step of calculating, when no SPA exists, the proration amount based, at least in part, a great circle calculation, in which the step of calculating comprises:
receiving an origin location for the shipping cargo;
receiving a destination location for the shipping cargo; and
calculating the proration amount based on a straight line distance from the origin location to the destination location and based on a percentage corresponding to the segment.

18. The apparatus of claim 14, in which the step of determining if the special prorate agreement (SPA) exists comprises searching an SPA database based, at least in part, on the segment and a host airline for the shipping cargo.

19. The apparatus of claim 19, in which the step of receiving a hurdle rate comprises receiving the hurdle rate from a Cargo Revenue Management (CRM) application that applies statistical algorithms to historical data received from a logistics management system (LMS) to forecast customer demand and available capacity.

20. The apparatus of claim 19, in which the hurdle rate is the minimum acceptable rate at which the product is to be sold for a booking segment.
